(19) United States
(12) Patent Application Publication
(10) Pub. No.: US 2023/0417907 A1
(43) Pub. Date: Dec. 28, 2023

(54) COEXISTENCE OF ULTRASONIC TRANSDUCERS IN AN OPERATING ENVIRONMENT

(71) Applicant: InvenSense, Inc., San Jose, CA (US)

(72) Inventors: Daniela Hall, Eybens (FR); Mitchell Kline, Alameda, CA (US); Joe Youssef, Noyarey (FR)

(73) Assignee: InvenSense, Inc., San Jose, CA (US)

(21) Appl. No.: 18/207,762

(22) Filed: Jun. 9, 2023

Related U.S. Application Data
(60) Provisional application No. 63/354,601, filed on Jun. 22, 2022.

(51) Int. Cl. G01S 15/10; G01S 15/04

(52) U.S. Cl. CPC G01S 15/105; G01S 15/04

(57) ABSTRACT

A device comprises a processor coupled with an ultrasonic transducer which is configured to repeatedly emit ultrasonic pulses during transmit periods which are interspersed with listening windows. Each sequential pair of the transmit periods is separated by a single listening window of the listening windows. During a fixed portion of a listening window of the listening windows the ultrasonic transducer is configured to receive returned signals corresponding to an emitted ultrasonic pulse of the ultrasonic pulses which was transmitted during a transmit period of the transmit periods that immediately preceded the listening window. The processor randomizes an overall length of each listening window of the listening windows. The processor directs filtering of returned signals received during a plurality of the randomized listening windows to achieve filtered returned signals. The processor detects, using the filtered returned signals, a moving object in a field of view of the ultrasonic transducer.

### REFERENCE TO RELATED APPLICATIONS

This application claims priority to and benefit of co-pending U.S. Provisional Patent Application No. 63/354,601, filed on Jun. 22, 2022, entitled “Method to Reduce False Positive Detections on Ultrasound Data Due to Presence of Other Ultrasound Sources,” by Daniela Hall, having attorney docket number IVS-1047-PR, and assigned to the assignee of the present application, the disclosure of which is hereby incorporated herein by reference in its entirety.

### BACKGROUND

A variety of devices exist which utilize ultrasonic sensing to detect the presence of moving and/or stationary objects in their operating environment. Some non-inclusive examples include personal computers, electronic door locks, and robotic vacuums. Some devices such as personal computers and electronic door locks may be stationary much of the time. Such stationary or mostly non-moving objects may use ultrasonic sensing to detect a potential approaching user in their operating environment so that they may, for example, begin exiting a power saving mode responsive to detecting a potential approaching user. Other devices, such as robotic vacuums or other vehicles, which move about such as on floors or other surfaces may use ultrasonic sensing to detect for moving and/or stationary objects in their operating environment to facilitate avoidance of such detected objects. It should be appreciated that these examples are only a small subset of the devices that may be utilizing ultrasonic signals for sensing in an operating environment such as a building, room, etc. Increasingly, because of this widespread use of ultrasonic sensors, there may be two or more devices emitting ultrasonic signals that may be received both by the emitting devices and by one or more other devices which share the same operating environment.

### BRIEF DESCRIPTION OF THE DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIGS. 1A and 1B show example block diagrams of some aspects of a device which uses ultrasonic signals to sense objects in its operating environment, in accordance with various embodiments.

FIG. 2A shows an operating environment in which a computer is using ultrasonic sensing to detect for the presence of potential users such as the human user depicted walking toward the computer, in accordance with various embodiments.

FIG. 2B shows an operating environment in which a pair of computers are using ultrasonic sensing with closely matched operating frequencies to detect for the presence of potential users and where one of the computers has a drift in the timing of its ultrasonic sensing, and where one or both of the computers are using ultrasonic sensing to detect for presence of a potential users, in accordance with various embodiments.

FIG. 2C shows an operating environment in which a pair of computers are using ultrasonic sensing with closely matched operating frequencies to detect for the presence of potential users and where one of the computers has a drift in the timing of its ultrasonic sensing and where one or both of the computers are using ultrasonic sensing to detect for presence of a potential users such as the human user depicted walking toward the computers, in accordance with various embodiments.

FIG. 3 illustrates an example transmit/receive timing diagram for an ultrasonic sensor along with several corresponding measurement diagrams of ultrasonic signals received during an approach of a human, in accordance with conventional sensing techniques.

FIG. 4 illustrates an example transmit/receive timing diagram for a first ultrasonic sensor, a transmission timing diagram for a second ultrasonic sensor, and several corresponding measurement diagrams showing ultrasonic signals transmitted by the second ultrasonic sensor and received by the first ultrasonic sensor, in accordance with conventional sensing techniques.

FIG. 5 illustrates an example flowchart for operating an ultrasonic sensor to avoid contention with and facilitate coexistence with other ultrasonic sensors, in accordance with various embodiments.

FIG. 6 illustrates states of an example state machine for determining an operating mode for a device, in accordance with various embodiments.

FIG. 7 illustrates portions of a single fixed rate sensing cycle of an ultrasonic transducer, in accordance with various embodiments.

FIG. 8A illustrates portions of and a maximum length of a randomized sensing cycle of an ultrasonic transducer, in accordance with various embodiments.

FIG. 8B illustrates portions of and a minimum length of a randomized sensing cycle of an ultrasonic transducer, in accordance with various embodiments.

FIG. 9 illustrates an example transmit/receive timing diagram for an ultrasonic sensor along with several corresponding measurement diagrams of ultrasonic signals received during an approach of a human, in accordance with various embodiments.

FIG. 10 illustrates an example transmit/receive timing diagram for a first ultrasonic sensor, a transmission timing diagram for a second ultrasonic sensor, and several corresponding measurement diagrams showing ultrasonic signals transmitted by the second ultrasonic sensor and received by the first ultrasonic sensor, in accordance with various embodiments.

FIG. 11 illustrates an example transmit/receive timing diagram for a first ultrasonic sensor, a transmission timing diagram for a second ultrasonic sensor, and several corresponding measurement diagrams showing ultrasonic signals received by the first ultrasonic sensor during an approach of a human along with ultrasonic signals transmitted by the second ultrasonic sensor and received by the first ultrasonic sensor, in accordance with various embodiments.

FIG. 12 illustrates a flow diagram of an example method of operating an ultrasonic transducer to facilitate coexistence with other ultrasonic sensors in the operating environment of the ultrasonic transducer, in accordance with various embodiments.

### DETAILED DESCRIPTION

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Overview of Discussion

As described previously, because of the widespread use of ultrasonic sensors, there may be two or more devices emitting ultrasonic signals that may be received both by the emitting device and by one or more other ultrasonic sensing devices which share the same operating environment. For example, a first device may sense signals from a second device and in some situations such as when the two devices operate at similar sensing cycle timing that overlaps transmit and receive periods or else drifts slightly relative to one another, the first device may interpret the received signals from the second device as a moving object—even if both devices are stationary. Such a false detection of a moving object may trigger the first device to take an unnecessary action such as powering up due to falsely interpreting a user is coming near or is present, or even taking an evasive maneuver due to falsely interpreting a collision with a moving object is imminent. Herein techniques are described replacing a regular fixed interval sensing cycles/measurement periods of an ultrasonic sensor with randomized sensing cycles/measurement periods which, overtime result in the same number of measurements as would be made during fixed (non-randomized) measurement periods over the same time span, because it is randomized around the fixed measurement period of the sensor. As described, this randomization facilitates coexistence of two or more ultrasonic sensors in a shared operating environment in which transmissions from the ultrasonic sensors can be received by other ultrasonic sensors in the environment. What is meant by “coexistence” is that, by virtue of the randomization of the sensing by an ultrasonic sensor, false detections of moving objects due to receipt of ultrasonic signals transmitted by other ultrasonic sensors will be either eliminated or reduced to the point they are nearly eliminated. For example, rather than having several false detections of a moving object per hour a device may go several hours (or longer) without a single false detection of a moving object. In this manner, problems caused by interference from neighboring ultrasonic sensors operating in the same environment is drastically reduced.

Discussion begins with a description of notation and nomenclature. Discussion then shifts to description of some block diagrams of example components of some example devices which utilize ultrasonic sensor. Some example depictions of a devices, in the form notebook computers, are discussed. Conventional sensing results are depicted to show how coexistence of devices with ultrasonic sensors can be frustrated, when one device senses ultrasonic signals transmitted by another. A high-level flowchart of the technique of randomized time-hopping of ultrasonic measurements is described, as well as a state diagram for determining an operating state of a device relative to detected presence of a potential user. Examples of fixed and randomized sensing cycles are depicted and described followed by examples of operation of ultrasonic sensing with randomization of sensing cycles is described. Finally, an example method of operating an ultrasonic transducer to facilitate coexistence with other ultrasonic sensors in the operating environment of the ultrasonic transducer, is described in accordance with various embodiments.

### Notation and Nomenclature

Some portions of the detailed descriptions which follow are presented in terms of procedures, logic blocks, processes, modules and other symbolic representations of operations on data bits within a computer memory. These descriptions and representations are the means used by those skilled in the data processing arts to most effectively convey the substance of their work to others skilled in the art. In the present application, a procedure, logic block, process, module, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device/component.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “controlling,” “randomizing,” “directing,” “filtering,” “detecting,” “emitting,” “transmitting,” “receiving,” “subtracting,” “selecting,” “low-pass filtering,” “median filtering,” “random sample consensus filtering,” “adjusting,” “employing,” “determining,” or the like, refer to the actions and processes of an electronic device or component such as: a host processor, a sensor processing unit, a sensor processor, a digital signal processor or other processor, a memory, a sonic sensor (e.g., an ultrasonic sensor/transducer), a device utilizing an ultrasonic sensor/transducer, some combination thereof, or the like. The electronic device/component manipulates and transforms data represented as physical (electronic and/or magnetic) quantities within the registers and memories into other data similarly represented as physical quantities within memories or registers or other such information storage, transmission, processing, or display components.

Embodiments described herein may be discussed in the general context of processor-executable instructions residing on some form of non-transitory processor-readable medium, such as program modules or logic, executed by one or more computers, processors, or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example electronic device(s) described herein may include components other than those shown, including well-known components.

The techniques described herein may be implemented in hardware, or a combination of hardware with firmware and/or software, unless specifically described as being implemented in a specific manner. Any features described as modules or components may also be implemented together in an integrated logic device or separately as discrete but interoperable logic devices. If implemented in software, the techniques may be realized at least in part by a non-transitory computer/processor-readable storage medium comprising computer/processor-readable instructions that, when executed, cause a processor and/or other components of a computer or electronic device to perform one or more of the methods described herein. The non-transitory processor-readable data storage medium may form part of a computer program product, which may include packaging materials.

The non-transitory processor-readable storage medium (also referred to as a non-transitory computer-readable storage medium) may comprise random access memory (RAM) such as synchronous dynamic random access memory (SDRAM), read only memory (ROM), non-volatile random access memory (NVRAM), electrically erasable programmable read-only memory (EEPROM), flash memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a plurality of microprocessors, one or more microprocessors in conjunction with an ASIC or DSP, or any other such configuration or suitable combination of processors.

In various example embodiments discussed herein, a chip is defined to include at least one substrate typically formed from a semiconductor material. A single chip may, for example, be formed from multiple substrates, where the substrates are mechanically bonded to preserve the functionality. Multiple chip (or multi-chip) includes at least two substrates, wherein the two substrates are electrically connected, but do not require mechanical bonding.

A package provides electrical connection between the bond pads on the chip (or for example a multi-chip module) to a metal lead that can be soldered to a printed circuit board (or PCB). A package typically comprises a substrate and a cover. An Integrated Circuit (IC) substrate may refer to a silicon substrate with electrical circuits, typically CMOS circuits but others are possible and anticipated. A MEMS substrate provides mechanical support for the MEMS structure(s). The MEMS structural layer is attached to the MEMS substrate. The MEMS substrate is also referred to as handle substrate or handle wafer. In some embodiments, the handle substrate serves as a cap to the MEMS structure.

Some embodiments may, for example, comprise one or more sonic sensors. This sensor may be any suitable sonic sensor operating in any suitable sonic range. For example, in some embodiments, the sonic sensor may be an ultrasonic sensor which utilizes a MEMs ultrasonic transducer. In some embodiments, the sonic sensor may include digital signal processor (DSP) which may be disposed as a part of an ASIC which may be integrated into the same package as a transducer. One example of such an ultrasonic sensor which may be utilized with various embodiments, without limitation thereto, is the CH101 ultrasonic range sensor and/or the CH201 long-range ultra-low-power integrated MEMS ultrasonic time-of-flight range sensor, both available from Chirp Microsystems, a TDK Group Company, of Berkley, California. The CH101 and the CH201 are only two examples of ultrasonic sensors, other types and/or brands of ultrasonic sensors may be similarly utilized.

Some embodiments may, for example, comprise one or more motion sensors along with one or more ultrasonic sensors. For example, an embodiment with one or more ultrasonic sensors may additionally be coupled with a 9-axis motion sensing device (e.g., an accelerometer, a gyroscope, and a magnetometer or other compass technology, which each provide a measurement along three axes that are orthogonal relative to each other). In another embodiment, one or more ultrasonic sensors may be coupled with a 6-axis motion sensing device (e.g., a three-axis accelerometer and a three-axis gyroscope). Other embodiments may, for example, comprise one or more ultrasonic sensors coupled with motion sensors that form a 10-axis device (e.g., an accelerometer, gyroscope, compass, and pressure sensor). Other embodiments may not include all the sensors or may provide measurements along one or more axes. Some or all of the sensors may be MEMS sensors. Some or all of the sensors may be incorporated in a sensor processing unit along with a sensor processor and disposed in a single semiconductor package.

In some embodiments, for example, one or more sensors may be formed on a first substrate. Various embodiments may, for example, include solid-state sensors and/or any other type of sensors. The electronic circuits in a sensor processing unit may, for example, receive measurement outputs from the one or more sensors. In various embodiments, the electronic circuits process the sensor data. The electronic circuits may, for example, be implemented on a second silicon substrate. In some embodiments, the first substrate may be vertically stacked, attached and electrically connected to the second substrate in a single semiconductor chip, while in other embodiments, the first substrate may be disposed laterally and electrically connected to the second substrate in a single semiconductor package, such as a single integrated circuit.

### Example Devices

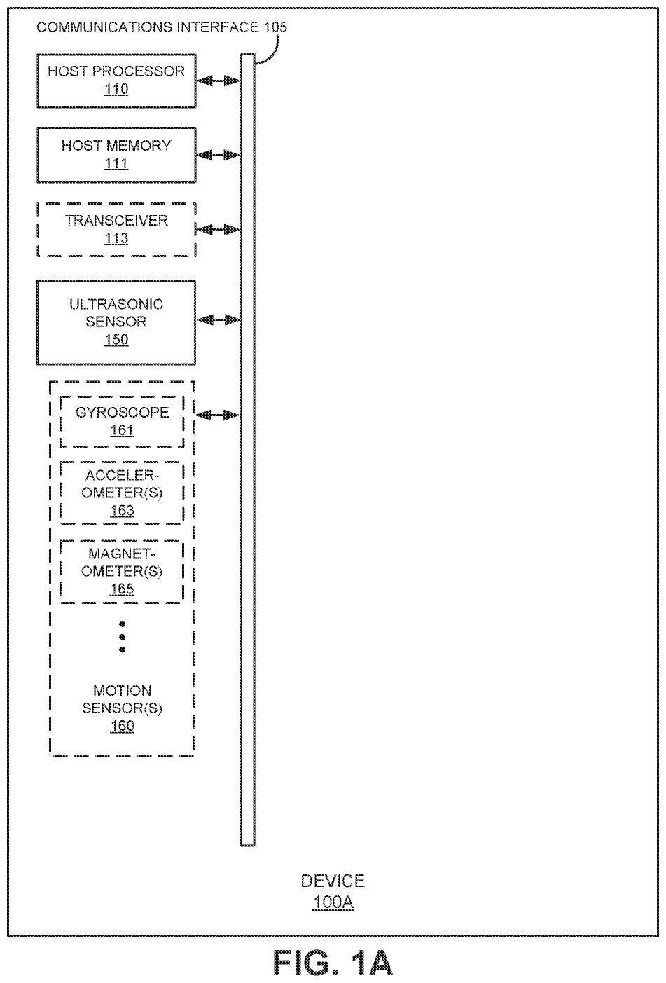

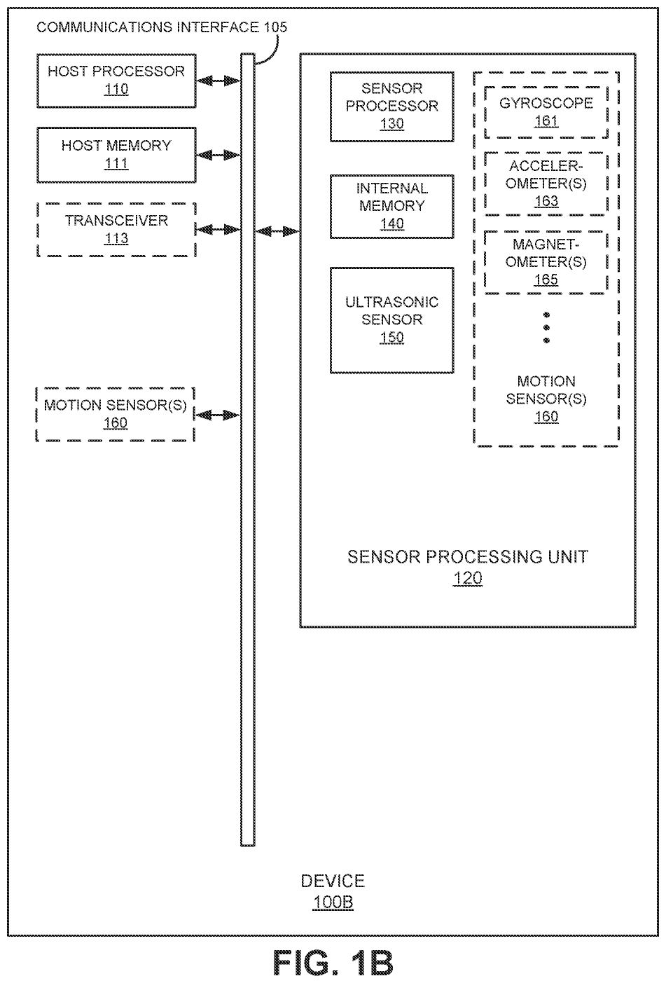

FIGS. 1A and 1B show example block diagrams of some aspects of a device 100 (e.g., 100A in FIG. 1A and/or 100B in FIG. 1B) which uses ultrasonic signals to sense objects in its operating environment, in accordance with various embodiments. The sensed objects may be stationary or moving, but a frequent interest is in detecting moving objects in the vicinity of the device 100 so that a responsive action may be taken by the device when a moving object (which may be a user) is detected. Herein, a device 100 may be any device that uses ultrasonic sensing. In an environment with a plurality of devices 100 some of the devices may be the same or different. For example, one device 100 may be a computer, while another device 100 may be robotic vacuum or an electronic door lock.

Attention is directed to FIG. 1A which shows a block diagram of components of an example device 100A which utilizes ultrasonic sensing to detect objects in its vicinity. As shown, example device 100A comprises a communications interface 105, a host processor 110, host memory 111, and at least one ultrasonic sensor 150. In some embodiments, device 100A may additionally include one or more of a transceiver 113, and one or more ultrasonic sensors 150 (an ultrasonic sensor may be an ultrasonic transducer which both transmits and receives). In some embodiments, device 100A may additionally include one or more motion sensors 160. Some embodiments may, for example, include additional sensors used to detect motion, position, user presence, or environmental context in the vicinity of device 100A. Some examples of these additional sensors may include, but are not limited to: infrared sensors, cameras, microphones, and/or global navigation satellite system sensors (i.e., a global positioning system receiver). As depicted in FIG. 1A, included components are communicatively coupled with one another, such as, via communications interface 105.

The host processor 110 may, for example, be configured to perform the various computations and operations involved with the general function of device 100A (e.g., sending commands to move, steer, avoid obstacles, and operate/control the operation of tools). Host processor 110 can be one or more microprocessors, central processing units (CPUs), DSPs, general purpose microprocessors, ASICs, ASIPs, FPGAs or other processors which run software programs or applications, which may be stored in host memory 111, associated with the general and conventional functions and capabilities of device 100A.

Communications interface 105 may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, or other equivalent and may include a plurality of communications interfaces. Communications interface 105 may facilitate communication between SPU 120 and one or more of host processor 110, host memory 111, transceiver 113, ultrasonic sensor 150, motion sensor(s) 160 (when included).

Host memory 111 may comprise programs, modules, applications, or other data for use by host processor 110. In some embodiments, host memory 111 may also hold information that that is received from or provided to sensor processing unit 120 (see e.g., FIG. 1B). Host memory 111 can be any suitable type of memory, including but not limited to electronic memory (e.g., read only memory (ROM), random access memory (RAM), or other electronic memory).

Transceiver 113, when included, may be one or more of a wired or wireless transceiver which facilitates receipt of data at device 100A from an external transmission source and transmission of data from device 100A to an external recipient. One example of an external transmission source/external recipient may be a base station to which device 100A returns for charging, maintenance, docking, etc. By way of example, and not of limitation, in various embodiments, transceiver 113 comprises one or more of: a cellular transceiver, a wireless local area network transceiver (e.g., a transceiver compliant with one or more Institute of Electrical and Electronics Engineers (IEEE) 802.11 specifications for wireless local area network communication), a wireless personal area network transceiver (e.g., a transceiver compliant with one or more IEEE 802.15 specifications (or the like) for wireless personal area network communication), and a wired a serial transceiver (e.g., a universal serial bus for wired communication).

Ultrasonic sensor 150 is typically a transducer but may include a dedicated ultrasonic transmitter and a separate dedicated ultrasonic receiver. In some embodiments, ultrasonic sensor 150 operates in the ultrasonic frequency range between 40 kHz and 200 kHz. Of course, other ultrasonic ranges are anticipated and usable. Ultrasonic sensor 150 is configured to transmit ultrasonic signals and receive ultrasonic returned signals. Returned signals include those that reflect from moving or stationary objects within the range (referred to herein as the vicinity) of the ultrasonic sensor 150 and thus within the vicinity of a device 100A which includes the ultrasonic sensor 150. It should be appreciated that embodiments may similarly include a sonic transducer which operates in the acoustic sound range, the infrasound, and or the ultrasound range.

Motion sensor(s) 160, when included, may be implemented as MEMS-based motion sensors, including inertial sensors such as a gyroscope 161 or accelerometer 163, or an electromagnetic sensor such as a Hall effect or Lorentz field magnetometer 165. In some embodiments, at least a portion of the motion sensors 160 may also, for example, be based on sensor technology other than MEMS technology (e.g., CMOS technology, etc.). As desired, one or more of the motion sensors 160 may be configured to provide raw data output measured along three orthogonal axes or any equivalent structure.

Attention is directed to FIG. 1B which shows a block diagram of components of an example device 100B which utilizes ultrasonic sensing to detect objects in its vicinity. Device 100B is similar to device 100A except that it includes a sensor processing unit (SPU) 120 in which ultrasonic sensor 150 is disposed. SPU 120, when included, comprises: a sensor processor 130; an internal memory 140; and at least one ultrasonic sensor 150. In some embodiments, SPU 120 may additionally include one or more motion sensors 160 (e.g., gyroscope 161, accelerometer 163, magnetometer 165) and/or one or more other sensors such a light sensor, infrared sensor, GNSS sensor, microphone, etc. In various embodiments, SPU 120 or a portion thereof, such as sensor processor 130, is communicatively coupled with host processor 110, host memory 111, and other components of device 100B through communications interface 105 or other well-known means. SPU 120 may also comprise one or more communications interfaces (not shown) similar to communications interface 105 and used for communications among one or more components within SPU 120.

Sensor processor 130 can be one or more microprocessors, CPUs, DSPs, general purpose microprocessors, ASICs, ASIPs, FPGAs or other processors that run software programs, which may be stored in memory such as internal memory 140 (or elsewhere), associated with the functions of SPU 120. In some embodiments, one or more of the functions described as being performed by sensor processor 130 may be shared with or performed in whole or in part by another processor of a device 100B, such as host processor 110.

Internal memory 140 can be any suitable type of memory, including but not limited to electronic memory (e.g., read only memory (ROM), random access memory (RAM), or other electronic memory). Internal memory 140 may store algorithms, routines, or other instructions for instructing sensor processor 130 on the processing of data output by one or more of the motion sensors 160 and/or one or more ultrasonic sensors 150. In some embodiments, internal memory 140 may store one or more modules which may be algorithms that execute on sensor processor 130 to perform a specific function. Some examples of modules may include, but are not limited to: statistical processing modules, motion processing modules, filtering modules, state detection modules, and/or decision-making modules.

Ultrasonic sensor 150 is typically a transducer but may include a dedicated ultrasonic transmitter and a separate dedicated ultrasonic receiver. In some embodiments, ultrasonic sensor 150 operates in the ultrasonic frequency range between 40 kHz and 200 kHz. Of course, other ultrasonic ranges are anticipated and usable. Ultrasonic sensor 150, in an ultrasonic transducer embodiment, is configured to transmit ultrasonic signals and receive ultrasonic returned signals. Returned signals include those that reflect from moving or stationary objects within the range (referred to herein as the vicinity) of the ultrasonic sensor 150 and thus within the vicinity of a device 100B which includes the ultrasonic sensor 150. It should be appreciated that embodiments may similarly include a sonic transducer which operates in the acoustic sound range, the infrasound, and or the ultrasound range.

In some embodiments, ultrasonic sensor 150 is an ultrasonic transducer, such as a PMUT (piezoelectric micromachined ultrasonic transducer). An ultrasonic sensor 150 may be large or small, depending on the application and the space available. In some embodiments, ultrasonic sensor 150 may be a MEMS device and may be very small, such as having a facing surface of less than 4 mm by 4 mm by 1.5 mm. In some embodiments, ultrasonic sensor 150 may be a SOC (system on a chip) which includes a DSP. In some embodiments, the SOC packaging of ultrasonic sensor 150 comprises sensor processing unit 120 and includes sensor processor 130 and internal memory 140.

Motion sensor(s) 160, when included, may be implemented as MEMS-based motion sensors, including inertial sensors such as a gyroscope 161 or accelerometer 163, or an electromagnetic sensor such as a Hall effect or Lorentz field magnetometer 165. In some embodiments, at least a portion of the motion sensors 160 may also, for example, be based on sensor technology other than MEMS technology (e.g., CMOS technology, etc.). As desired, one or more of the motion sensors 160 may be configured to provide raw data output measured along three orthogonal axes or any equivalent structure.

### Example of Device(s) Using Ultrasonic Sensing

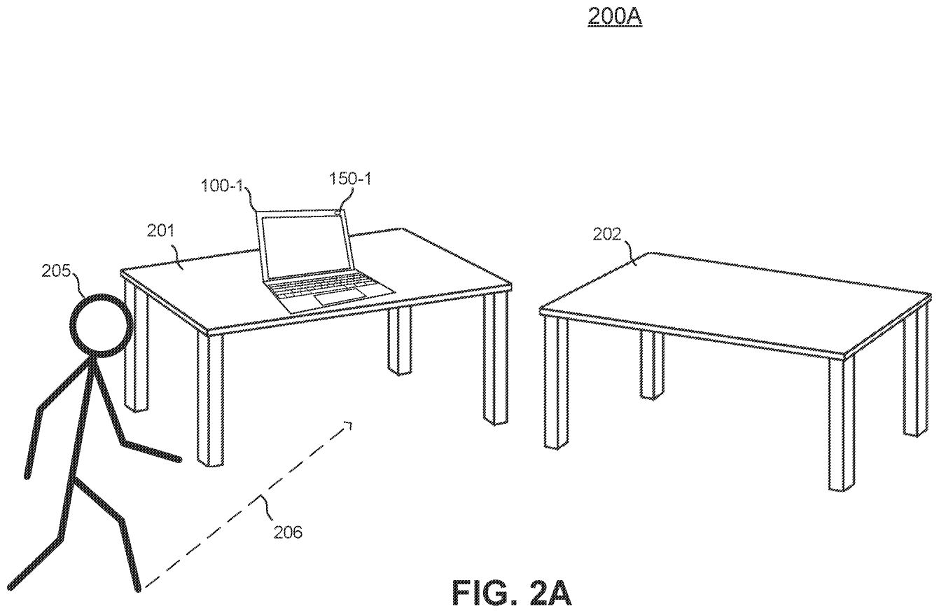

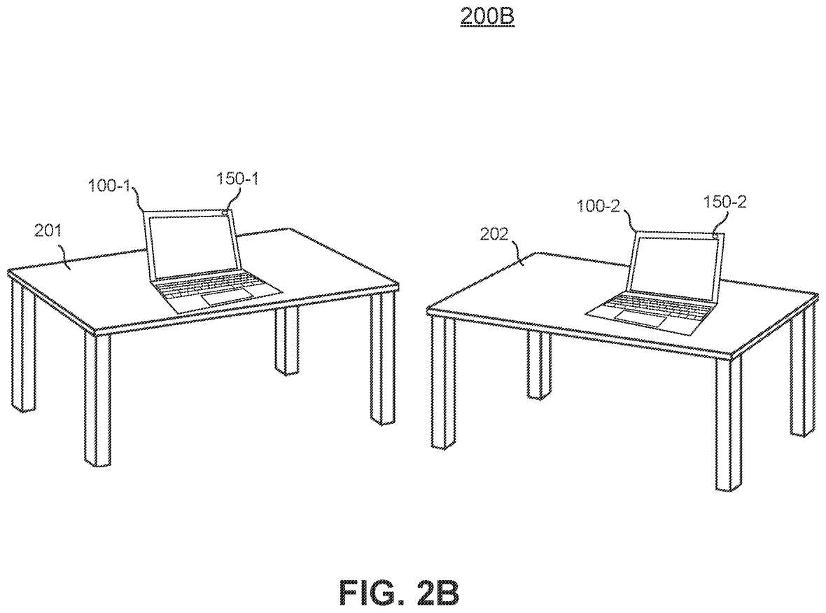

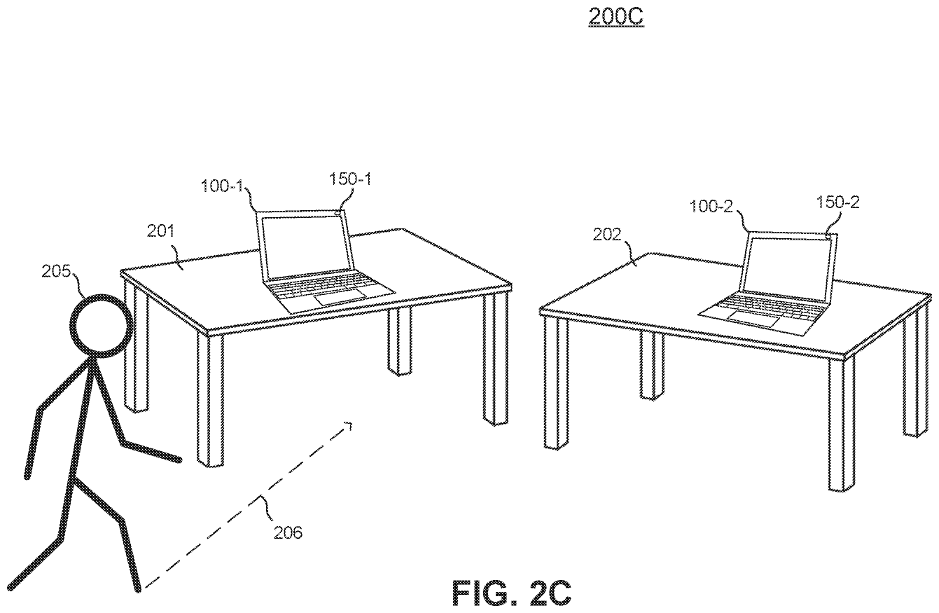

FIG. 2A shows an operating environment 200A with a first device 100 (e.g., a device such as 100A or 100B) in the form of computer 100-1. The environment 200A includes a first table 201 upon which computer 100-1 is disposed, a second table 202, and a human 205 walking on a path 206 toward computer 100-1. Computer 100-1 is employing an ultrasonic sensor 150-1 to detect, using ultrasonic sensing, for the presence of potential users such as the human user 205 depicted walking toward computer 100-1.

FIG. 2B shows an operating environment 200B with a device 100 (e.g., a device such as 100A or 100B) in the form of computer 100-1 and a second device 100 (e.g., a device such as 100A or 100B) in the form of computer 100-2. The environment 200B includes a first table 201 upon which computer 100-1 is disposed and a second table 202 upon which computer 100-2 is disposed. Computer 100-1 is employing an ultrasonic sensor 150-1 to detect, using ultrasonic sensing, for the presence of potential users walking toward computer 100-1. Similarly, computer 100-2 is also employing an ultrasonic sensor 150-2 to detect, using ultrasonic sensing, for the presence of potential users walking toward computer 100-2. In this environment, ultrasonic sensor 150-1 is receiving ultrasonic signals transmitted by ultrasonic sensor 150-2.

FIG. 2C shows an operating environment 200C with a device (e.g., a device such as 100A or 100B) in the form of computer 100-1 and a second device 100 (e.g., a device such as 100A or 100B) in the form of computer 100-2. The environment 200B includes a first table 201 upon which computer 100-1 is disposed, a second table 202 upon which computer 100-2 is disposed, and a human 205 walking on a path 206 toward computer 100-1. Computer 100-1 is employing an ultrasonic sensor 150-1 to detect, using ultrasonic sensing, for the presence of potential users such as the human user 205 depicted walking toward computer 100-1, in accordance with various embodiments. Computer 100-1 is employing an ultrasonic sensor 150-1 to detect, using ultrasonic sensing, for the presence of potential users (such as human user 205) walking toward computer 100-1. Similarly, computer 100-2 is also employing an ultrasonic sensor 150-2 to detect, using ultrasonic sensing, for the presence of potential users walking toward computer 100-2. In this environment, ultrasonic sensor 150-1 is receiving ultrasonic signals transmitted by ultrasonic sensor 150-2.

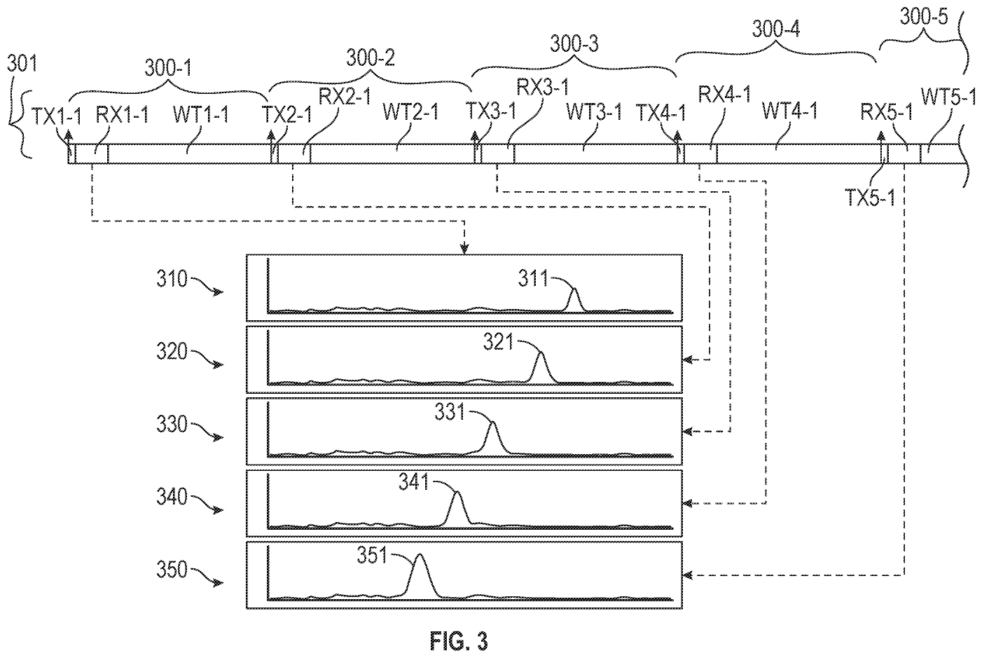

FIG. 3 illustrates an example transmit/receive timing diagram 301 for an ultrasonic sensor 150-1 of device 100-1 along with several corresponding measurement diagrams (310, 320, 330, 340, and 350) of ultrasonic signals received during an approach of a human such as in FIG. 2A, in accordance with conventional sensing techniques. Five sensing cycles 300 (300-1, 300-2, 300-3, 300-4, and 300-5) at a fixed rate are illustrated. The sensing is performed in environment 200A of FIG. 2A.

Each sensing cycle includes a transmit period TX during which an ultrasonic pulse (represented by a corresponding upward directed arrow) is transmitted, a receive period RX during which the ultrasonic transducer receives ultrasonic signals, and a wait period WT when the ultrasonic sensor is doing nothing but waiting to start the next sensing cycle. At a fixed rate, the sensing cycles are typically at a fixed and repeated length which may vary slightly based on a drift in timing but is otherwise uniform. Within a sensing cycle, the receive period (RX) and the wait period (WT) together form a fixed length listening window. Sensing cycle 300-1 comprises transmit period TX1-1, receive period RX1-1, and wait period WT1-1. Sensing cycle 300-2 comprises transmit period TX2-1, receive period RX2-1, and wait period WT2-1. Sensing cycle 300-3 comprises transmit period TX3-1, receive period RX3-1, and wait period WT3-1. Sensing cycle 300-4 comprises transmit period TX4-1, receive period RX4-1, and wait period WT4-1. Sensing cycle 300-5 comprises transmit period TX5-1, receive period RX5-1, and wait period WT5-1.

With reference to FIG. 3 and to FIG. 2A, as human 205 walks closer to computer 100-1 movement is detected by the received ultrasonic signals depicted in diagrams 310, 320, 330, 340, and 350. Each of these measurement diagrams depicts samples over time on its x-axis and amplitude on its y-axis. As human 205 nears computer 100-1, sensed peaks 311, 321, 331, 341, and 351 appear sooner in the samples and gradually increase in amplitude.

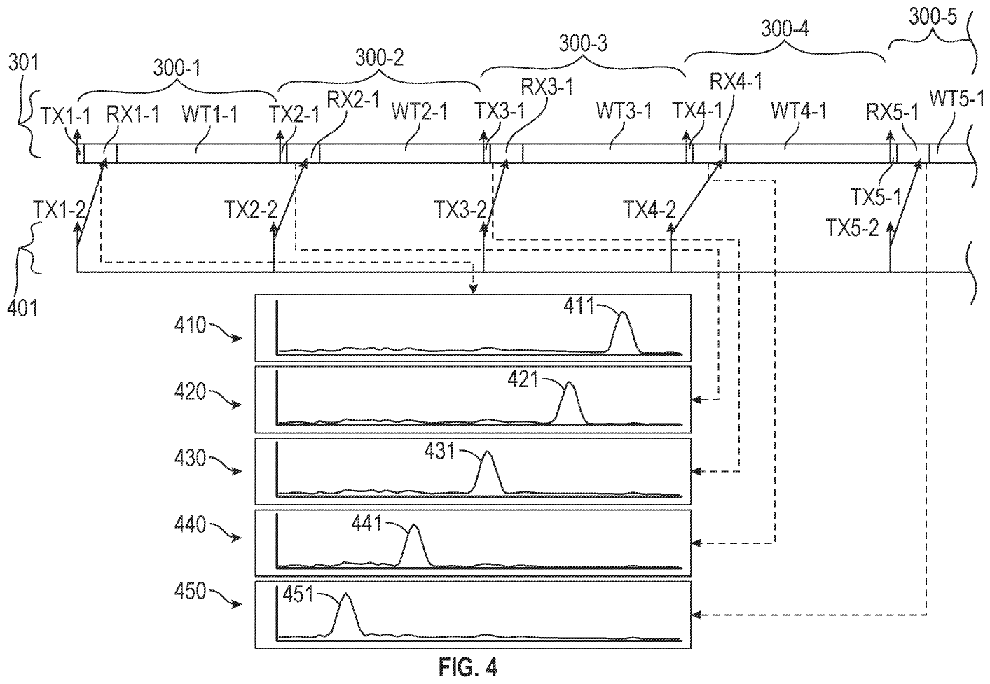

FIG. 4 illustrates an example transmit/receive timing diagram 301 for an ultrasonic sensor 150-1 of device 100-1 along with several corresponding measurement diagrams (410, 420, 430, 440, and 450) of ultrasonic signals received due to receipt of ultrasonic transmissions of sensor 150-2 (as depicted in FIG. 2B). Each of these measurement diagrams (410, 420, 430, 440, and 450) depicts samples over time on its x-axis and amplitude on its y-axis. The same five sensing cycles (300-1, 300-2, 300-3, 300-4, and 300-5) from FIG. 3, at a fixed rate, are illustrated. The difference between FIG. 3 and FIG. 4 is that FIG. 4 depicts sensing in environment 200B of FIG. 2B.

A timing diagram 401 for the transmissions from ultrasonic sensor 150-2 is provided. The sensing cycles in timing diagram 401 are not labeled, however they are fixed in length and similar in frequency to the cycles 300-1, 300-2, 300-3, 300-4, and 300-5 of ultrasonic sensor 150-1. A problem which conventionally frustrates coexistence is that they are drifting slightly earlier in time, as shown by the slight leftward drift of the TX arrows in timing diagram 401 relative to the transmit periods of timing diagram 301.

With reference to FIG. 4 and to FIG. 2B as the transmitted ultrasonic signals (TX1-2, TX2-2, TX3-2, TX4-2, and TX5-2) from sensor 150-2 drift earlier in time (as depicted by the leftward shift) relative to the sensing cycles (300-1, 300-2, 300-3, 300-4, and 300-5) and receive periods (RX1-1, RX2-1, RX3-1, RX4-1, and Rx5-1) of ultrasonic sensor 150-1, their receipt results in a series of amplitude peaks (411, 421, 431, 441, and 451) which are similar in amplitude to one another but occur progressively earlier in the sequential sensing cycles (300-1, 300-2, 300-3, 300-4, and 300-5) for ultrasonic sensor 150-1. It should be noted that because peaks 411, 421, 431, 441, and 451 follow a similar pattern of precession to that of peaks 311, 321, 331, 341, and 351 that are illustrated in FIG. 3, they can trigger a false detection of a moving/approaching object. This is a problem conventional sensing techniques face when multiple ultrasonic sensors operate in a shared operating environment and interfere with each other to cause false sensing of moving objects that are not present and/or interfere with the sensing of stationary or moving objects that are present.

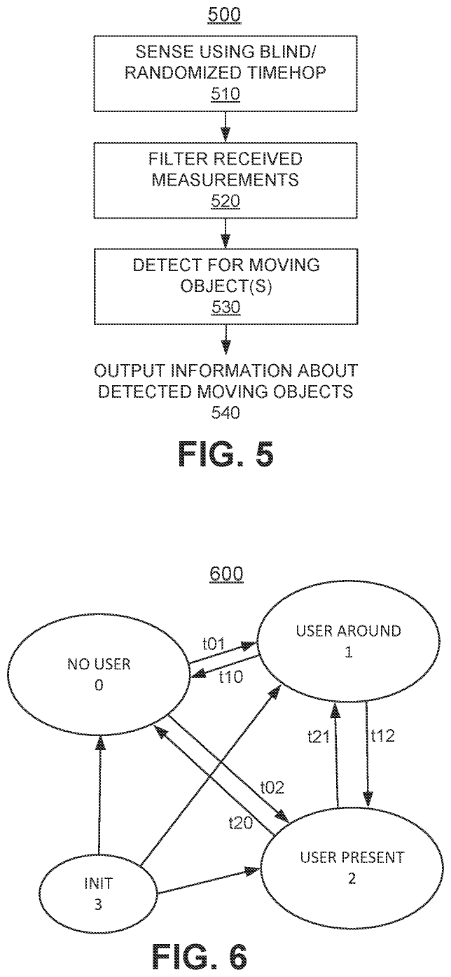

FIG. 5 illustrates an example flowchart 500 for operating an ultrasonic sensor to avoid contention with and facilitate coexistence with other ultrasonic sensors, in accordance with various embodiments. By avoiding contention and interference through use of the described technique, multiple ultrasonic sensors can coexist within a shared sensing environment (e.g., 200A, 200B, 200C, etc.) by reducing or eliminating cases of interference, especially those that result in false positive cases of sensing a moving object.

At 510 of flowchart 500, sensing is switched from a fixed rate with fixed sensing cycles to a blind time-hopping sensing where the overall length of sensing cycles (and particularly the length of a listening window within a sensing cycle) is randomized (i.e., time-hopped in a blind, unscheduled fashion) from sensing cycle to sensing cycle. The randomization occurs within a defined range using available techniques for randomizing in defined units (e.g., 1 ms units over a 20 ms range) and, over time, results in the same number or substantially the same number of sensing cycles as sensing with a fixed rate. By substantially, what is meant is that over a long enough period such as 10 to 30 seconds, the difference of the number of sensing cycles between fixed and randomized sensing cycles may be only a few percent or even less than a single percent; a difference which is, essentially, negligible. In other embodiments, blind-time hopping may already be enabled or be enabled at all times, in which case procedure 510 may be superfluous.

At 520 of flowchart 500, measurements received using the randomized sensing cycles are filtered or otherwise cleaned to remove noise and to prepare the measurements for object detection algorithms. This results in filtered measurements. A variety of filters may be used, some examples of which include but are not limited to: a low pass filter, a median filter, and/or a random sample consensus filter. When using a median filter, for example, an odd number of samples is used such as 3, 5, 7, 11, etc., and the number of samples is shorter than the number of samples acquired during a receive period of a randomized sensing cycle.

At 530 of flowchart 500, detection for moving objects occurs. The detection may be accomplished using a detection algorithm, many of which are known in the art, which is repurposed to process filtered samples acquired by the randomized/blind time-hopping sampling rather than by fixed sampling. A difference is that measurements acquired by the randomized sensing cycles inherently remove some sensed peaks and patterns that would appear in measurements from fixed sensing cycles and which might trigger the false detection of an object. In particular, precessing patterns associated with receipt of drifting ultrasonic transmissions of another ultrasonic sensor are disrupted by the randomized sensing cycles.

At 540 of flowchart 500, the method outputs information about detected moving objects. This information about detected moving objects may be output with information regarding static targets (e.g., non-moving objects such as walls, tables, chairs) that are static in the vicinity of an ultrasonic sensor 150 removed or filtered out. In some embodiments, this information about detected moving objects may be provided as an input to a state machine which can analyze detected moving objects to determine a mode in which a device 100 (e.g., device 100-1) should be operating.

FIG. 6 illustrates states of an example state machine 600 for determining an operating mode for a device 100 (e.g., 100-1, 100-2, etc.). State machine 600 has four states based upon detection (or not) of a potential human user by an ultrasonic sensor (e.g., ultrasonic sensor 150-1), in accordance with various embodiments. The four states include an “initial” state (state 3), “no user” detected (state 0); “user around” (state 1), and “user present” (state 2). State 0 is associated with startup or initialization. State 1 is associated with a user being around or in the vicinity of a device 100 (e.g., 1-5 meters away, in one embodiment). State 2 is associated with a user being present at a device 100 (e.g., within 1 meter of the device, in one embodiment). State 3 is associated with a user not being either present or around device 100 (e.g., not detected within 5 meters, in one embodiment). It should be appreciated that the four states that are shown are by way of example and not of limitation, for example three states could be implemented with states 1 and 2 combined or with state 0 used for an initial state. In other embodiments, additional states may be added, for example to provide further differentiation with regard to how close a user is, how fast a user is approaching, etc.

Upon being informed of these states by state machine 600 a device 100 can respond by initiating an appropriate mode of operation. For example, in some embodiments, in state 3 device 100 enters or remains in a sleep or low power mode in state; in state 1 a device initiates or remains in semi-powered-up mode with a screen saver operating; and in state 2 a device initiates or remains in a fully powered mode with a log-in screen presented, a home screen presented, etc. In other embodiments, other modes of operation of device 100 may be assigned to one or more of the states identified by state machine 600.

Transitions (t) from state (I) to state (J) are labeled are depicted with directional arrows and labeled tIJ. For example, a transition from state 0 to state 1 is depicted with an arrow pointing from state 0 to state 1 and labeled t01. In a like fashion transition from: state 1 to state 0 is labeled t10; transition from state 1 to state 2 is labeled t12; transition from state 2 to state 1 is labeled t21; transition from state 0 to state 2 is labeled t02; and transition from state 2 to state 0 is labeled t20. Transition from the “initial” state (3) to any of the operational states 0, 1, or 2 is illustrated only by a directional arrow.

Transitions between states are based on conditions computed from the energy in close range (either leaving or approaching) in measured samples. For example, the amplitude variances over a plurality of samples, such as the last six frames (e.g., last 6 sensing cycles), may be summed and compared to a threshold which indicates a transfer from one state to another state should take place. Other conditions which may additionally or alternatively be used to determine transitions between states include a number of mobile targets detected, the range to the closest mobile target (which may be referred to as the range index), variance of the amplitude over time (e.g., increasing, declining, not changing). When a condition of the various conditions is met for a transfer between states during a sensing cycle, a transition counter is incremented. A transition takes place when the transition counter exceeds a pre-established threshold. The counter ensures that a transition between states is only triggered if/when the conditions hold for several sensing frames.

Transition from the “initial” state 3 to any of the operational states 0, 1, or 2 may occur to any of states 0, 1, or 2 based on energy detected and/or moving objects detected satisfying a criterion for a particular state. Alternatively, in some embodiments, the transition from the “initial” state 3 to one of states 1, 2, or 3 may be random upon startup of state machine 600 or to a certain preselected state as a default after startup of state machine 600.

To initiate a transition from “no user” state 0 to “user present” state 2 (i.e., t02) the state machine 600 monitors close range energy in ultrasonic measurements. When close range energy is greater than a preset energy threshold for a preset number of measurement frames (e.g., 8 frames, 10 frames, 12 frames) then state transition t02 is triggered.

To initiate a transition from “user present” state 2 to “no user” state 0 (transition t20) or to “user around” (transition t21) state machine 600 monitors close range energy in ultrasonic measurements. When close range energy is less than a preset energy threshold or is no energy for a preset number of measurement frames (e.g., 8 frames, 10 frames, 12 frames, etc.) then a state change transition is triggered. State change is transition t21 occurs when one or more mobile targets are detected in a distance associated with the “user around” state, otherwise state transition t20 is triggered because state machine 600 has determined there is “no user” either present (close to device 100) or around (farther away than “present” but still in the vicinity of device 100).

To initiate a transition from “user around” state 1 to “no user” state 0 (transition t10) state machine 600 monitors close range energy in ultrasonic measurements. When close range energy is less than a preset energy threshold for a preset number of measurement frames (e.g., 8 frames, 10 frames, 12 frames, etc.) or no mobile target is detected for a certain number of measurement frames (e.g., 3 frames, 4 frames, 5 frames, etc.), then state transition t10 is triggered. As can be seen, in some embodiments the threshold number of frames for no moving objects detected is lower than the threshold number of frames for low energy detected. In some embodiments, a combination of no moving objects and energy below a threshold for a certain number of measurement frames may trigger transition t10.

To initiate a transition from “user around” state 1 to “user present” state 2 (transition t12) state machine 600 monitors close range energy in ultrasonic measurements. When close range energy is greater than a preset energy threshold for a preset threshold number of measurement frames (e.g., 8 frames, 10 frames, 12 frames, etc.), then state transition t12 is triggered.

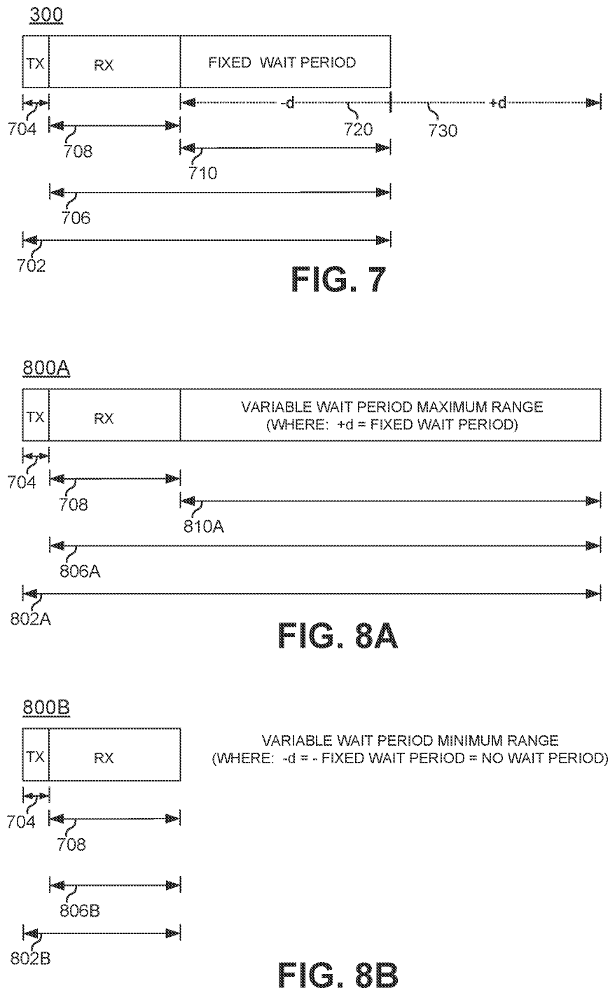

FIG. 7 illustrates portions of a single fixed rate sensing cycle 300 of an ultrasonic sensor 150 (e.g., a transducer which both transmits and receives), in accordance with various embodiments. This may be any of the sensing cycles 300 depicted in FIG. 3 or FIG. 4. Sensing cycle 300 represents one cycle of ultrasonic sensing by an ultrasonic sensor 150 which has a fixed length 702 in time that is dictated by the fixed sensing cycle rate of ultrasonic sensor 150. For example, the cycle rate of sensing cycles may be 10 Hz or 100 ms and the ultrasonic sensor may transmit at 80 kHz. The sample includes a fixed length transmit time period 704 such as 0.375 ms a fixed listening window 706. The listening window 706 is the time when no transmitting is taking place and comprises a fixed receive period 708 for receiving ultrasonic signals and a fixed waiting period 710 that follows it before the start of the next sensing cycle. In an embodiment where the fixed receive period 708 is 18 ms, the waiting period 710 is approximately 81.625 ms (e.g., the remainder of the sensing cycle not used by the transmit period or the receive period). This is 81 ms full milliseconds.

Embodiments described herein modify the overall length of a fixed sample by randomly adding or subtracting delay (d) from the existing fixed waiting period 710 which is part of the listening window 706. Dashed line 730 shows the maximum range that the fixed length 702 of sensing cycle 300 can be randomly adjusted upward/longer by adding delay (shown as +d) to the fixed length of the fixed waiting period 710; while dashed line 720 shows the maximum range that the fixed length 702 of sensing cycle 300 can be adjusted downward/shorter by subtracting delay (shown as −d) from the fixed waiting period 710. A randomized waiting period of a listening window has a maximum and minimum length. The maximum length is generally at or approximately double the length of the fixed waiting period 710 as shown in FIG. 8A, while the minimum length may be zero, or no waiting period, as shown in FIG. 8B.

Although FIGS. 8A and 8B show maximum and minimum cases for delay randomization, it should be appreciated that the value of d can be set anywhere at or below the maximum, but that certain small values below 3 ms may not provide enough time for sufficient randomization. In the illustrated examples, the value of “d” is an integer value in milliseconds that is not greater than the number of milliseconds of fixed wait period 710 but may be shorter. Amount of delay (d) to add or subtract is randomly selected using known means of randomization, from within the range of +/−d for each randomized sensing cycle 800 (see FIGS. 8A and 8B). For example, the value of d may be +/−3 ms in one embodiment or +/−23 ms in another embodiment.

Attention is directed to FIG. 8A which illustrates portions of and a maximum length of a randomized sensing cycle 800A of an ultrasonic sensor 150 (e.g., a transducer which both transmits and receives), in accordance with various embodiments. Sensing cycle 800A represents one cycle of ultrasonic sensing by an ultrasonic sensor 150 which has its length randomly adjusted from a fixed length 702 (see FIG. 7) of time associated with a fixed rate of sensing cycles. As depicted sensing cycle 800A instead has a randomized overall length 802A which is randomized around that fixed length 702 by adding a maximum amount of delay (+d). For example, the fixed rate may be 10 Hz or 100 ms and the ultrasonic sensor may transmit at 80 kHz. The sample includes a fixed transmit time period 704 such as 0.375 ms and a randomized listening window 806A. The randomized listening window 806A comprises a fixed receive period 708 for receiving ultrasonic signals and randomized waiting period 810A that follows it prior to the start of the next sensing cycle.

Attention is directed to FIG. 8B which illustrates portions of and a minimum length of a randomized sensing cycle 800B of an ultrasonic sensor 150 (e.g., a transducer which both transmits and receives), in accordance with various embodiments. Sensing cycle 800B represents one cycle of ultrasonic sensing by an ultrasonic sensor 150 which has its length randomly adjusted from a fixed length 702 (see FIG. 7) of time associated with a fixed sample of a fixed sensing cycle rate. As depicted sensing cycle 800B instead has a randomized overall length 802B which is randomized around that fixed length 702 by subtracting a maximum amount of delay (−d). By setting −d at the at the full time length of wait period, the randomized wait period becomes zero, or no wait period—which is why no wait period is depicted. In this example, the fixed length receive period 708 effectively becomes the entire listening window 806B.

In an embodiment where the fixed receive period 708 is 18 ms, the fixed transmit period is 0.375 ms, and the overall sample period is 100 ms, subtraction shows the fixed wait period 710 to by ˜81 ms and thus the max/min range for a randomized wait period 810 is approximately +/−81 ms relative to the fixed waiting period 710. In some embodiments, the randomization may be in discrete increments such as 1 ms, meaning in this example it can randomly be varied in 1 ms increments between being 0 ms (minimum) to 162 ms (maximum). The maximum range does not have to be utilized for randomization, instead a shorter +/− range such as +/−19 ms of fixed wait period 710 may be used as the range for randomizing a wait period 810. It has been empirically determined that the shortest range for randomization which provides a good probability of prevention of overlap of echo peaks between ultrasonic sensors is about +/−3 ms of the fixed wait period. Smaller ranges may be used, but probability of contention via overlap of echo peaks increases, potentially to an unacceptable level, as ranges decrease further. Likewise, when smaller ranges than +/−3 ms are used the ability to disrupt patterns of precession from drifting ultrasonic signals is diminished.

In other embodiments the maximum range of the randomized listening window may be different depending on the fixed sensing cycle rate around which it is based. For example, consider an ultrasonic sensor 150 with a fixed cycle rate of 50 ms with the same fixed receive period of 18 ms and the same fixed transmit period of 0.375 ms described above. By subtraction of the fixed transmit period and the fixed receive period from the length of the fixed cycle, the fixed wait period would be ˜31 ms. In this example a randomized wait period could be randomized in increments (such as 1 ms)+/−31 ms from the fixed length wait period (i.e., the randomized wait period could range in randomized increments from 0 ms to 62 ms). Because the randomization in increments (e.g., 1 ms increments) is balanced within the same range above and below the fixed wait period (e.g., a range of +/−3 ms, +/−27 ms, +/−31 ms, etc.), over time the randomized sensing cycle rate will average out to the same number of sensing cycles per second as the fixed sensing cycle rate.

In another example, consider an ultrasonic sensor 150 with a fixed sensing cycle rate of 100 ms with a fixed receive period of 48 ms and a fixed transmit period of 0.8 ms described above. By subtraction of the fixed transmit period and the fixed receive period from the sensing cycle rate, the fixed wait period would be ˜51 ms. In this example a randomized wait period could be randomized in increments (such as 1 ms)+/−51 ms from the fixed length wait period (i.e., the randomized wait period could range in randomized increments from 0 ms to 102 ms). Because the randomization is balanced with the same range above and below the fixed wait period (e.g., +/−3 ms, +/−27 ms, +/−51 ms), over time the randomized sensing cycle rate will average out to the same as the fixed sensing cycle rate.

It should be appreciated that in some embodiments there may be other fixed periods in a sensing cycle, such as a sleep period between the transmit and receive period. Inclusion of other fixed periods may reduce the overall range available for randomizing the wait period of the listening window.

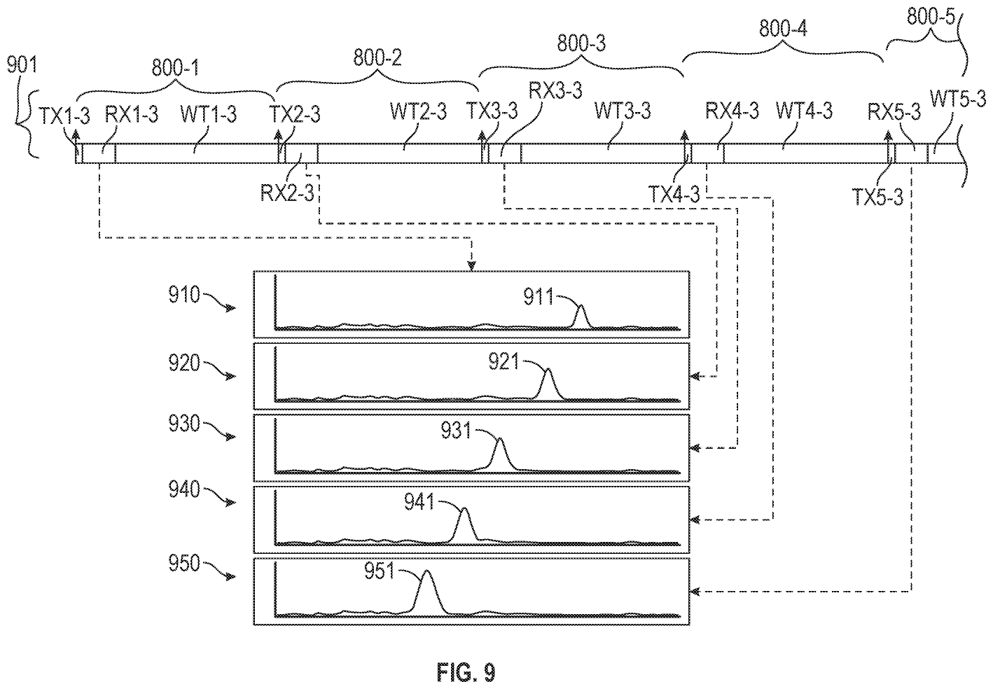

FIG. 9 illustrates an example transmit/receive timing diagram 901 for an ultrasonic sensor 150-1 of a device 100-1 along with several corresponding measurement diagrams (910, 920, 930, 940, and 950) of ultrasonic signals received during an approach of a human such as in FIG. 2A, in accordance with various embodiments. Five randomized sensing cycles 800 (800-1, 800-2, 800-3, 800-4, and 800-5) which are randomized around a fixed sensing cycle rate are illustrated. In the illustrated example, the ultrasonic measurements are acquired in environment 200A of FIG. 2A.

Each sensing cycle 800 includes a fixed transmit period TX during which an ultrasonic pulse (represented by a corresponding upward directed arrow) is transmitted, a fixed receive period RX during which the ultrasonic transducer receives ultrasonic signals, and a randomized wait period WT when the ultrasonic sensor is doing nothing but waiting to start the next sensing cycle. Within a sensing cycle, the receive period RX and the randomized wait period WT together form a random length listening window in the manner described in conjunction with FIGS. 8A and 8B. Sensing cycle 800-1 comprises transmit period TX1-3, receive period RX1-3 and randomized wait period WT1-3. Sensing cycle 800-2 comprises transmit period TX2-3, receive period RX2-3, and randomized wait period WT2-3. Sensing cycle 800-3 comprises transmit period TX3-3, receive period RX3-3, and randomized wait period WT3-3. Sensing cycle 800-4 comprises transmit period TX4-3, receive period RX4-3, and randomized wait period WT4-3. Sensing cycle 800-5 comprises transmit period TX5-3, receive period RX5-3, and randomized wait period WT5-3. Waiting periods WT1-1, WT1-2, WT1-3, WT1-4, and WT1-5 are all randomized around a fixed waiting period (e.g., WT1-1 of FIG. 3) by randomly adding or subtracting delay within a range of +/−d, as has been previously described in conjunction with FIG. 7, FIG. 8A, and FIG. 8B. Thus, the depicted sensing cycles 800-1, 800-2, 800-3, 800-4, and 800-5 all have different time lengths from one another.

With reference to FIG. 9 along with reference to FIG. 8 and FIG. 2A, as human 205 walks closer to computer 100-1 movement is detected by the received ultrasonic signals depicted in measurement diagrams 910, 920, 930, 940, and 950. Each of these measurement diagrams depicts samples over time on its x-axis and amplitude on its y-axis. As human 205 nears computer 100-1, sensed peaks 911, 921, 931, 941, and 951 appear sooner in the samples and gradually increase in amplitude. The measurements depicted in the measurement diagrams of FIG. 8 are similar in amplitude and separation to those of the measurement diagrams depicted in FIG. 3. This is because the measurements are of a moving human 205 who is actually present and thus generates returned signals in each sensing cycle 800.

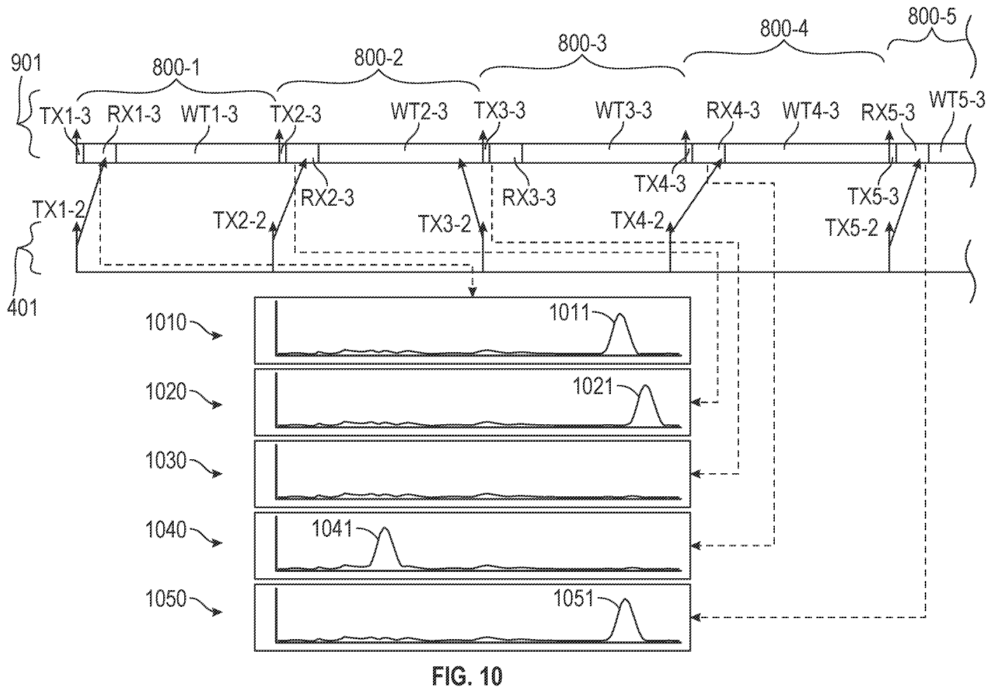

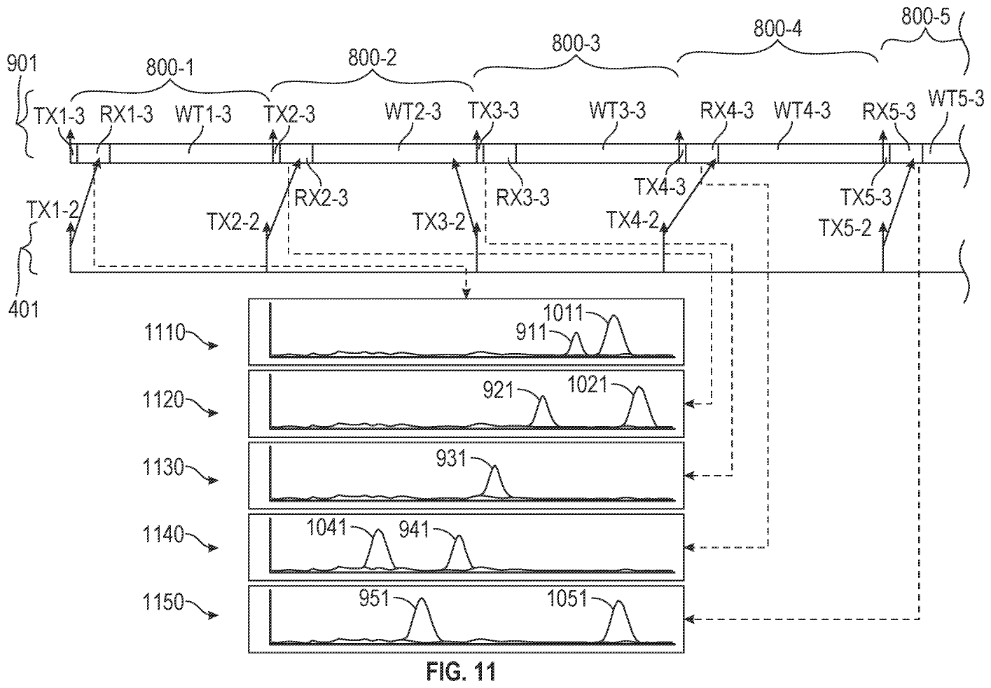

FIG. 10 illustrates an example transmit/receive timing diagram 901 for an ultrasonic sensor 150-1 of a device 100-1 along with several corresponding measurement diagrams (910, 920, 930, 940, and 950) of ultrasonic signals due to receipt of ultrasonic transmissions of a second ultrasonic sensor 150-2 (as depicted in FIG. 2B), in accordance with various embodiments. Five randomized sensing cycles 800 (800-1, 800-2, 800-3, 800-4, and 800-5) which are randomized around a fixed sensing cycle rate are illustrated. In the illustrated example, the ultrasonic measurements are acquired in environment 200B of FIG. 2B.

Each of these measurement diagrams (1010, 1020, 1030, 1040, and 1050) depicts samples over time on its x-axis and amplitude on its y-axis. The same five sensing cycles 800 (800-1, 800-2, 800-3, 800-4, and 800-5) from FIG. 9 are illustrated. The difference between FIG. 9 and FIG. 10 is that FIG. 10 depicts ultrasonic sensing and measurements acquired in environment 200B of FIG. 2B.

A timing diagram 401 for the transmissions from ultrasonic sensor 150-2 is provided. The sensing cycles in timing diagram 401 are not labeled, however they are fixed in length as was previously described in FIG. 4. Because of randomization of sensing cycles 800 (800-1, 800-2, 800-3, 800-4, and 800-5) relative to a fixed sensing cycle rate of ultrasonic sensor 150-1, the precessing illustrated in FIG. 4 no longer exists in the peaks (1011, 1021, 1041, and 1051) of measurement diagrams 1010, 1020, 1030, 1040, and 1050. Instead, the peaks occur at random locations in the sequential measurement diagrams, and in in one measurement diagram (1030) a peak due does not appear at all because ultrasonic transmission TX3-2 arrives during a waiting period (WT2-3) and is not “received” by ultrasonic sensor 150-1.

In this manner, the precessing problem of conventional fixed rate sensing cycles, illustrated in FIG. 4, is eliminated or drastically reduced and thus the corresponding false detection of moving objects is also eliminated or drastically reduced.

FIG. 11 illustrates an example transmit/receive timing diagram 901 for an ultrasonic sensor 150-1 of a device 100-1 and several corresponding measurement diagrams (1110, 1120, 1130, 1140, and 1150) showing ultrasonic signals received by the first ultrasonic sensor during an approach of a human along with ultrasonic signals received due to receipt of ultrasonic transmissions of a second ultrasonic sensor 150-2 (as depicted in FIG. 2C), in accordance with various embodiments. Five randomized sensing cycles 800 (800-1, 800-2, 800-3, 800-4, and 800-5) which are randomized around a fixed sensing cycle rate are illustrated. In the illustrated example, the ultrasonic measurements are acquired in environment 200C of FIG. 2C.

FIG. 11 combines the measurements of FIGS. 9 and 10, and shows the associated amplitude peaks 911, 1011, 921, 1021, 931, 941, 1041, 951, and 1051 from both of these figures. The positioning of the peaks shows how randomization of sensing cycles 800 generally prevents overlapping of peaks due to approaching human 205 and due to receipt of transmissions from ultrasonic sensor 150-2. While overlapping may occur, because of the randomization, it is unlikely to occur in sequential frames. This not only reduces false sensing of moving objects, but it also reduces large energy spikes that would falsely indicate a very large moving object or exaggerate the actual amplitude of a sensed moving object.

### Example Methods of Operation

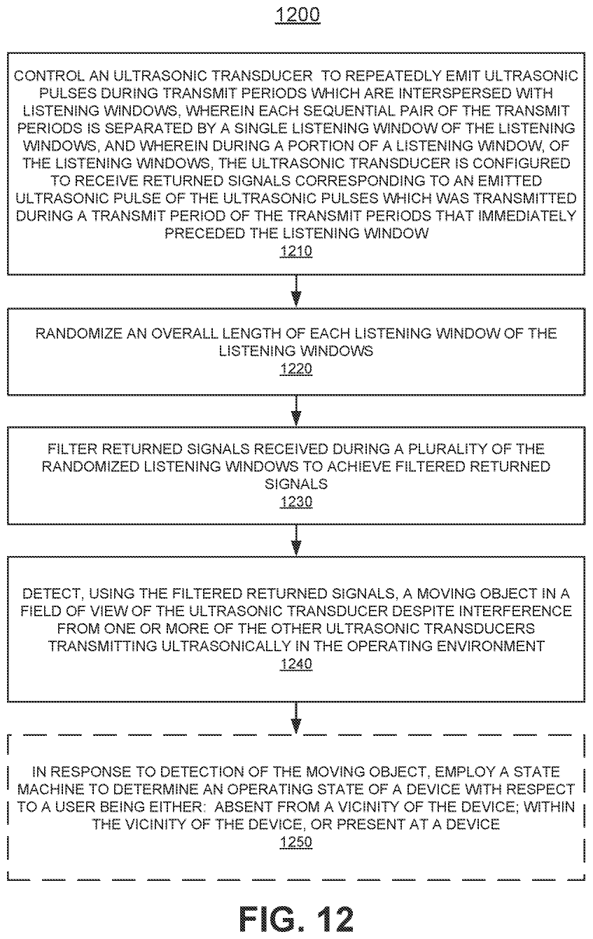

FIG. 12 illustrates a flow diagram 1200 of an example method of operating an ultrasonic transducer to facilitate coexistence with other ultrasonic transducers in the operating environment of the ultrasonic transducer, in accordance with various aspects of the present disclosure. Procedures of these example methods will be described with reference to elements and/or components of one or more of FIGS. 1A-11. It is appreciated that in some embodiments, the procedures may be performed in a different order than described, that some of the described procedures may not be performed, and/or that one or more additional procedures to those described may be performed. Flow diagram 1200 includes some procedures that, in various embodiments, are or may be carried out by one or more processors (e.g., host processor 110, sensor processor 130, or the like) under the control of computer-readable and computer-executable instructions that are stored on non-transitory computer-readable storage media (e.g., host memory 111, internal memory 140, or the like). It is further appreciated that one or more procedures described in flow diagram 1200 and/or may be implemented in hardware, or a combination of hardware with firmware and/or software.

With reference to FIG. 12, at procedure 1210 of flow diagram 1200, in various embodiments, an ultrasonic sensor 150 (e.g., 150-1 of FIGS. 2A, 2B, and 2C) repeatedly emits ultrasonic pulses during transmit periods which are interspersed with listening windows. In the described example, the ultrasonic sensor 150 is a transducer which both transmits and receives. Each sequential pair of the transmit periods is separated by a single listening window of the listening windows. During a portion of a listening window, of the listening windows, the ultrasonic sensor 150 is configured to receive returned signals corresponding to an emitted ultrasonic pulse of the ultrasonic pulses which was transmitted during a transmit period of the transmit periods that immediately preceded the listening window. In some embodiments, a processor such as host processor 110 or sensor processor 130 controls the ultrasonic transducer to perform the emitting and receiving to sense objects in the vicinity of the ultrasonic sensor. In some embodiments, the ultrasonic transducer has a frequency of operation of between 40 kHz and 200 kHz, although other broader and narrower ranges are anticipated.

With continued reference to FIG. 12, at procedure 1220 of flow diagram 1200, in various embodiments, an overall length of each listening window of the listening windows is randomized. The randomization may be carried out or directed by a processor such as host processor 110 or sensor processor 130, in some embodiments. As described in conjunction with FIGS. 7, 8A, 8B, and 9, in some embodiments, the randomizing of each listening window 806 (e.g., 806A, 806B and/or a randomized period between these maximum and minimum listening window lengths) of the listening windows is conducted in a manner such that a fixed sensing cycle rate in samples per second, of the ultrasonic sensor 150, is unchanged over time (e.g., over several seconds or tens of seconds depending on conditions). This means the randomization occurs such that, on average over a sufficient length of time, the same number of samples per second occur with or without the randomization of each listening window.

In various embodiments, a listening window (e.g., 806) of the listening windows comprises the fixed portion (e.g., receive period 708) and a second portion (e.g., wait period 810) and wherein the randomizing, by the processor, an overall length of each listening window of the listening windows comprises: adjusting the second portion plus or minus by a random delay period (e.g., in discrete increments within a defined range of +/−d), wherein a minimum adjusted time length and a maximum adjusted time length of the second portion are defined by a sensing cycle rate of the ultrasonic transducer. That is, as a function of the sensing cycle rate, there are fixed portions of a sensing cycle which cannot be omitted and there is a fixed amount of waiting time in a sensing cycle that is available for randomizing up/down in the manner described herein. More particularly, each listening window (e.g., 806) of the listening windows in a plurality of sensing cycles comprises the fixed portion (e.g., receive period 708) and a second portion (e.g., wait period 810) which is adjusted plus or minus by a random delay period “d”, and wherein a minimum adjusted time length and a maximum adjusted time length of the second portion are defined by a sensing cycle rate of the ultrasonic transducer. That is, when d is set to be equal to a wait period associated with a sensing cycle in a fixed sensing cycle rate, then the maximum value of a waiting period with d added would be twice the delay period of the fixed rate's sensing cycle. Similarly, when d is set to be equal to a wait period associated with a sensing cycle in a fixed rate, then the minimum value of a waiting period with d subtracted would be no delay period.

In this fashion, the maximum range of the random delay period (e.g., +/−d) is plus or minus a value of d found by subtracting both a time length of an emitted pulse of the ultrasonic transducer and a second time length of the fixed portion of the listening window from a period associated with one cycle at the fixed sensing cycle rate of the ultrasonic transducer. By way of example, consider an ultrasonic sensor 150 with a fixed sensing cycle rate of 100 ms with a fixed receive period of 40 ms and a fixed transmit period of 1 ms. By subtraction of the fixed transmit period and the fixed receive period from the sensing cycle rate, the fixed wait period, and thus the value of d, would be 59 ms.

With continued reference to FIG. 12, at procedure 1230 of flow diagram 1200, in various embodiments, the returned signals received during a plurality of the randomized listening windows are filtered returned signals. That is, the filtering effectively removes noise and other signal peaks that are not associated with returned signals from pulses transmitted by the ultrasonic transducer, leaving only or predominately filtered returned signals. Any suitable filtering may be used, to include one or more of: low pass filtering; median filtering; and random sample consensus filtering. When median filtering is used, an odd number of samples are used (i.e., the median filter size is an odd number) and the number of samples is shorter than the receive window of a sensing cycle. For example, with reference to FIG. 11, in some embodiments the filtering would remove peaks 1011, 1021, 1041 and 1051 and leave peaks 911, 921, 931, 941, and 951. In other embodiments, all of these peaks would remain after filtering and a movement detector would discern that peaks 911, 921, 931, 941, and 951 were associated with a moving object and discern that peaks 1011, 1021, 1041 and 1051 and were not associated with a moving object. In some embodiments, a processor such as host processor 110 or sensor processor 130 carries out or directs the filtering.

With continued reference to FIG. 12, at procedure 1240 of flow diagram 1200, in various embodiments, the filtered returned signals and additionally or alternatively any other filtered signals are used to detect a moving object in a field of view of the ultrasonic transducer. This is despite interference from one or more of the other ultrasonic transducers transmitting that are ultrasonically transmitting in the operating environment. In some embodiments, a processor such as host processor 110 or sensor processor 130 carries out or directs the detection for moving objects in the filtered returned signals and/or any other filtered signals. In this manner, two or more ultrasonic sensors can coexist within a common operating environment by minimizing or eliminating negative impacts of ultrasonic noise/crosstalk that might otherwise cause false positive sensing of a non-existent moving object or obscure the sensing of an actual moving object.

For example, and with reference to FIG. 11, consider an embodiment where the filtering of procedure 520 (see FIG. 5) leaves peaks 911, 921, 931, 941, and 951 but removes peaks 1011, 1021, 1041 and 1051. The movement detection 530 (see FIG. 5) would determine that peaks 911, 921, 931, 941, and 951 represent a moving object in the field of view of ultrasonic sensor 150 and that it is moving closer. In another embodiments, where all of the peaks 911, 921, 931, 941, 951, 1011, 1021, 1041 and 1051 remain after the filtering, movement detection would discern that peaks 911, 921, 931, 941, and 951 were associated with a moving object and discern that peaks 1011, 1021, 1041 and 1051 and were not associated with a moving object.

With continued reference to FIG. 12, at procedure 1250 of flow diagram 1200, in various embodiments the method as described in 1210-1240 may further comprise, in response to detection of the moving object, employment of a state machine such as state machine 600 to determine an operating state of a device (e.g., device 100-1) with respect to a user being either: absent from a vicinity of the device; within the vicinity of the device, or present at a device. In some embodiments, a processor such as host processor 110 or sensor processor 130 controls or operates the state machine 600.

For example, with reference to the detection of a moving of an object/human 205 in diagram 1140 from peaks 911, 921, 931, 941, and 951, state machine 600 would determine in the manner previously described whether this moving object triggered transition to state 1 (user around) or to state 2 (user present). Based on the determined state, a processor such as host processor 110 or sensor processor 130, can either direct device 100-1 to take a predetermined action/switch to a certain operational mode or pass the state determination on to device 100-1 so that other processors may determine an action, mode, and/or response of device 100-1 with respect to the determined state.

### CONCLUSION

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims. Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed:

1. A device comprising:
an ultrasonic transducer configured to repeatedly emit ultrasonic pulses during transmit periods which are interspersed with listening windows, wherein each sequential pair of the transmit periods is separated by a single listening window of the listening windows, and wherein during a fixed portion of a listening window of the listening windows the ultrasonic transducer is configured to receive returned signals corresponding to an emitted ultrasonic pulse of the ultrasonic pulses which was transmitted during a transmit period of the transmit periods that immediately preceded the listening window; and
a processor coupled with the ultrasonic transducer and configured to:
randomize, by the processor, an overall length of each listening window of the listening windows;
direct, by the processor, filtering of returned signals received during a plurality of the randomized listening windows to achieve filtered returned signals; and
detect, by the processor using the filtered returned signals, a moving object in a field of view of the ultrasonic transducer.

2. The device of claim 1, wherein the ultrasonic transducer has a frequency of operation of between 40 kHz to 200 kHz.

3. The device of claim 1, wherein the ultrasonic transducer has a fixed sensing cycle rate in cycles per second which is unchanged over time by the randomization of each listening window of the listening windows, such that on average the same number of sensing cycles per second occur with or without the randomization of each listening window.

4. The device of claim 1, wherein each listening window of the listening windows comprises the fixed portion and a second portion which is adjusted plus or minus by a random delay period, and wherein a minimum adjusted time length and a maximum adjusted time length of the second portion are defined by a sensing cycle rate of the ultrasonic transducer.

5. The device of claim 4, wherein a maximum range of the random delay period is plus or minus a value found by subtracting both a time length of an emitted pulse of the ultrasonic transducer and a second time length of the fixed portion of the listening window from a period associated with one cycle at the fixed sensing cycle rate of the ultrasonic transducer.

6. The device of claim 1, wherein the directed filtering is selected from the types of filtering consisting of: low-pass filtering; median filtering; and random sample consensus filtering.

7. The device of claim 1, wherein the directed filtering comprises median filtering with an odd median filter size that is shorter than the receive window.

8. A sensor processing unit comprising:
an ultrasonic transducer configured to repeatedly emit ultrasonic pulses during transmit periods which are interspersed with listening windows, wherein each sequential pair of the transmit periods is separated by a single listening window of the listening windows, and wherein during a fixed portion of a listening window of the listening windows the ultrasonic transducer is configured to receive returned signals corresponding to an emitted ultrasonic pulse of the ultrasonic pulses which was transmitted during a transmit period of the transmit periods which immediately preceded the listening window; and
a sensor processor coupled with the ultrasonic transducer and configured to:
randomize, by the sensor processor, an overall length of each listening window of the listening windows;
direct, by the sensor processor, filtering of returned signals received during a plurality of the randomized listening windows to achieve filtered returned signals; and
detect, by the sensor processor using the filtered returned signals, a moving object in a field of view of the ultrasonic transducer.

9. The sensor processing unit of claim 8, wherein the ultrasonic transducer has a frequency of operation of between 40 kHz and 200 kHz.

10. The sensor processing unit of claim 8, wherein the ultrasonic transducer has a fixed sensing cycle rate in samples per second which is unchanged over time by the randomization of each listening window of the listening windows, such that on average the same number of sensing cycles per second occur with or without the randomization of each listening window.

11. The sensor processing unit of claim 8, wherein each listening window of the listening windows comprises the fixed portion and a second portion which is adjusted plus or minus by a random delay period, wherein a minimum adjusted time length and a maximum adjusted time length of the second portion are defined by a fixed sensing cycle rate of the ultrasonic transducer.

12. The sensor processing unit of claim 11, wherein a maximum range of the random delay period plus or minus a value found by subtracting both a time length of an emitted pulse of the ultrasonic transducer and a second time length of the fixed portion of the listening window from a period associated with one sensing cycle at the fixed sensing cycle rate of the ultrasonic transducer.

13. The sensor processing unit of claim 8, wherein the directed filtering is selected from the types of filtering consisting of: low-pass filtering; median filtering; and random sample consensus filtering.

14. The sensor processing unit of claim 8, wherein the directed filtering comprises median filtering with an odd median filter size that is shorter than the receive window.

15. A method of operating an ultrasonic transducer to facilitate coexistence with other ultrasonic transducers in the operating environment of the ultrasonic transducer, the method comprising:
controlling, by a processor, the ultrasonic transducer to repeatedly emit ultrasonic pulses during transmit periods which are interspersed with listening windows, wherein each sequential pair of the transmit periods is separated by a single listening window of the listening windows, and wherein during a portion of a listening window, of the listening windows, the ultrasonic transducer is configured to receive returned signals corresponding to an emitted ultrasonic pulse of the ultrasonic pulses which was transmitted during a transmit period of the transmit periods that immediately preceded the listening window;
randomizing, by the processor, an overall length of each listening window of the listening windows;
filtering returned signals received during a plurality of the randomized listening windows to achieve filtered returned signals; and
detecting, by the processor using the filtered returned signals, a moving object in a field of view of the ultrasonic transducer despite interference from one or more of the other ultrasonic transducers transmitting ultrasonically in the operating environment.

16. The method as recited in claim 15, further comprising:
responsive to detection of the moving object, employing a state machine to determine an operating state of a device with respect to a user being either: absent from a vicinity of the device; within the vicinity of the device, or present at a device.

17. The method as recited in claim 15, wherein the randomizing, by the processor, an overall length of each listening window of the listening windows comprises:
randomizing each listening window of the listening windows such that a fixed sensing cycle rate in sensing cycles per second, of the ultrasonic transducer, is unchanged over time, such that on average the same number of sensing cycles per second occur with or without the randomization of each listening window.

18. The method as recited in claim 15, wherein each listening window of the listening windows comprises the fixed portion and a second portion and wherein the randomizing, by the processor, an overall length of each listening window of the listening windows comprises:
adjusting the second portion plus or minus by a random delay period, wherein a minimum adjusted time length and a maximum adjusted time length of the second portion are defined by a fixed sensing cycle rate of the ultrasonic transducer.

19. The method as recited in claim 17, wherein the filtering returned signals received during a plurality of the listening windows to achieve filtered returned signals comprises:
filtering the returned signals received during the plurality of the listening windows using at least one of: low-pass filtering; median filtering; and random sample consensus filtering.

20. The method as recited in claim 17, wherein the filtering returned signals received during a plurality of the listening windows to achieve filtered returned signals comprises:
filtering returned signals received during a plurality of the listening windows, by the processor, using an odd median filtering size that is shorter than the receive window.
